(19) United States
(12) Patent Application Publication
(10) Pub. No.: US 2008/0081030 A1
(43) Pub. Date: Apr. 3, 2008

(54) Termite bait and processes related thereto

(75) Inventors: Joseph J. DeMark, Westfield, IN (US); Dennis G. Wujek, Zionsville, IN (US); Mike P. Tolley, Indianapolis, IN (US); James E. King, Carmel, IN (US); Martin C. Logan, Indianapolis, IN (US)

Correspondence Address: DOW AGROSCIENCES LLC, 9330 ZIONSVILLE RD, INDIANAPOLIS, IN, 46268, US

(73) Assignee: Dow AgroSciences LLC, Indianapolis, IN (US)

(21) Appl. No.: 11/904,942

(22) Filed: Sep. 28, 2007

Related U.S. Application Data
(60) Provisional application No. 60/847,803, filed on Sep. 28, 2006.

(51) Int. Cl. A01N 25/00; A01M 1/20

(52) U.S. Cl. 424/84; 43/124

(57) ABSTRACT

A termite bait comprising cellulose, at least one sugar, and at least one acid is provided. This termite bait can further comprise at least one insecticide. Furthermore, this termite bait can be encased in or contained in a durable material. Additionally, a process to make such termite baits is provided. Additionally, a process comprising placing such a termite bait in an area where at least one termite would be able to come across said termite bait is provided.

### CROSS-REFERENCE TO RELATED APPLICATIONS

This application is related to, and claims priority from, provisional application 60/847,803, which was filed on Sep. 28, 2006 in the United States Patent and Trademark Office.

### BACKGROUND OF THE INVENTION

This invention is related to the field of termite baits and related processes.

Termites are pests because they eat cellulose. Termites attack buildings, furniture, fences, utility poles, and other wooden objects. Termites also destroy products other than wood such as paper, books, clothing, shoes, and leather items. Termites also injure living trees and shrubs. Termites are known to chew through concrete and plastics. It has been estimated that control and repair costs due to just subterranean termites cost billions of U.S. Dollars each year. This impacts the average homeowner in the United States of America because typical home insurance excludes termite damage. Besides the monetary impact, termites inflict immeasurable amounts of distress to homeowners. For example, having termites emerging inside one's home is distressing and the thought of termites eating one's home (usually the homeowner's largest investment) is frightening. Furthermore, in a survey of homeowners, more than ninety percent expressed concern over the prospect of finding termites in their home. A similar high percentage believed termites ate wood quickly and cause extensive damage in a short period of time. Half of all respondents estimated that an infestation of termites could cause serious structural damage to a home in six months or less. Because of all of the reasons above, research is constantly being conducted to control or eradicate termites. However, while some success has been made, further inventions are needed in order to more fully combat this growing problem.

### SUMMARY OF THE INVENTION

A termite bait comprising cellulose, at least one sugar, and at least one acid is provided. This termite bait can further comprise at least one insecticide. Furthermore, this termite bait can be encased in or contained in a durable material. Additionally, a process to make such termite baits is provided. Additionally, a process comprising placing such a termite bait in an area where at least one termite would be able to come across said termite bait is provided.

### DETAILED DESCRIPTION OF THE INVENTION

Termites can be controlled by the termite baits disclosed herein, especially such termites as Reticulitermes spp., Heterotermes spp., and Coptotermes spp. Suitable examples of termites that can be controlled are: Reticulitermes flavipes; Reticulitermes virginicus; Reticulitermes Hesperus; Heterotermes aureus; Coptotermes formosanus; Reticulitermes speratus; Reticulitermes grassei; Reticulitermes santonensis; Macrotermes gilvus; and Reticulitermes hageni.

Cellulose is a long-chain polymeric polysaccharide carbohydrate of glucose. It forms the primary structural component of wood. Wood contains about fifty weight percent cellulose and cotton contains about ninety weight percent cellulose. Cellulose is also sometimes used as a generic term for a composition that contains alpha cellulose, beta cellulose, and gamma cellulose. Alpha cellulose has a much higher degree of polymerization (“DP”) than beta or gamma cellulose. Alpha cellulose has a DP in the thousands depending on the source of the alpha cellulose. Alpha cellulose is readily available and can be purchased from a variety of sources. Alpha cellulose can be made into microcrystalline cellulose. Microcrystalline cellulose has a DP of less than about 400.

Sugars include monosaccharides, disaccharides, trisaccharides, and oligosaccharides (which contain four or more monosaccharides linked together, but generally less than about fifty monosaccharides). Sugars include, but are not limited to, fructose, galactose, glucose, lactose, maltose, mannose, and sucrose.

Acids are generally considered any compound that when dissolved in water, gives a solution with a pH of less than 7. Two general categories of acids are inorganic acids and organic acids. Common examples include, but are not limited to, Acetic acid, Adipic acid, Alginic acid, Ascorbic acid, Benzoic acid, Boric acid, Butyric acid, Carbonic acid, Carminic acid, Chloric acid, Citric acid, Cyclamic acid, Erythorbic acid, Erythorbin acid, Formic acid, Fumaric acid, Gluconic acid, Glutamic acid, Glutaric Acid, Guanylic acid, Hydrobromic acid, Hydrochloric acid, Hydrofluoric acid, Hydroiodic acid, Inosinic acid, Lactic acid, Malic acid, Malonic acid, Mandelic acid, Metatartaric acid, Methanethiol, Nicotinic acid, Nitric acid, Oxalic acid, Pectic acid, Perchloric acid, Phosphoric acid, Propionic acid, Pyrophosphoric acid, Pyruvic acid, Sorbic acid, Stearic acid, Succinic acid, Sulfuric acid, Tannic acid, Tartaric acid, and Valeric acid.

Examples of suitable insecticides that may be used are:

pyrethroids, such as permethrin, cypemethrin, fenvalerate, esfenvalerate, deltamethrin, cyhalothrin, lambda-cyhalothrin, gamma-cyhalothrin, bifenthrin, fenpropathrin, cyfluthrin, tefluthrin, fish safe pyrethroids (for example ethofenprox), natural pyrethrin, tetramethrin, s-bioallethrin, fenfluthrin, prallethrin, 5-benzyl-3-furylmethyl-(E)-(1R,3S)-2,2-dimethyl-3-(2-oxothiolan-3-ylidenemethyl) cyclopropane carboxylate, or any of their insecticidally active isomers;

organophosphates, such as, methidathion, chlorpyrifos-methyl, profenofos, sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, chlorpyrifos-methyl, phosalone, terbufos, fensulfothion, fonofos, phorate, phoxim, pirimiphos-methyl, pirimiphos-ethyl, fenitrothion, fosthiazate or diazinon;

carbamates (including aryl carbamates), such as fenoxycarb, alanycarb, pirimicarb, triazamate, cloethocarb, carbofuran, furathiocarb, ethiofencarb, aldicarb, thiofurox, carbosulfan, bendiocarb, fenobucarb, propoxur, methomyl or oxamyl;

benzoyl ureas, such as lufenuron, novaluron, noviflumuron, teflubenzuron, diflubenzuron, triflumuron, hexaflumuron, flufenoxuron, bistrifluron, or chlorfluazuron;

organic tin compounds, such as cyhexatin, fenbutatin oxide or azocyclotin;

pyrazoles, such as tolfenpyrad, pyridaben, tebufenpyrad and fenpyroximate;

macrolides, such as avermectins or milbemycins, for example abamectin, emamectin benzoate, ivermectin, milbemycin, spinosad or azadirachtin;

hormones or pheromones;

organochlorine compounds such as endosulfan, benzene hexachloride, DDT, chlordane or dieldrin;

amidines, such as chlordimeform or amitraz;

chloronicotinyl compounds such as diofenolan, clothianidin, thiacloprid, imidacloprid, thiacloprid, acetamiprid, nitenpyram or thiamethoxam;

diacylhydrazines, such as halofenozide, tebufenozide, chromafenozide or methoxyfenozide;

diphenyl ethers, such as diofenolan or pyriproxifen;

indoxacarb;

chlorfenapyr;

pymetrozine;

diafenthiuron;

toxins of microbial origin such as Bacillus thuringiensis endo- or exotoxins;

phenylpyrazoles such as fipronil, vanilliprole, etiprole or acetoprole;

pyridalyl; or

hydramethylnon

Specific examples of preferred insecticides are thiamethoxam, abamectin, emamectin benzoate, spinosad, chlorpyrifos, chlorpyrifos-methyl, profenofos, lufenuron, indoxacarb, gamma-cyhalothrin, pymetrozine, pirimicarb, methidathion, imidacloprid, acetamiprid, thiacloprid, fipronil, methoxyfenozide, chlorfenapyr, pyridaben, novaluron, noviflumuron, hexaflumuron, pyridalyl, propargite, and piperonyl butoxide. Mixtures of pesticides are also useful and many of the above can be synergistically used together. However, it is most preferred to use a slow acting insecticide, so that the termites can take the insecticide, or insecticides, back to their colony and poison other colony members.

The components of the termite bait can be mixed together in any manner known in the art. In general the amount of components to use is not critical and can vary by a wide amount depending on the other factors (such as insecticide(s), binder(s), attractant(s), etc.) added to mixture to form into the termite bait. Suitable ranges for the main components are given in Table 1.

TABLE 1

| | Approximate Weight Percent | | |
|---|---|---|---|
| | (based on total weight of these components) | | |
| Component | Broad Range | Broader Range | Broadest Range |
| Cellulose | about 80-90% | about 70-95% | about 50-99% |
| Sugar | about 5-15% | about 3-20% | about 0.1-25% |
| Acid | about 0.1-5% | about 0.1-10% | about 0.1-25% |

In general the amount of insecticide to use is also not critical. Amounts from 0.0001 to 20 weight percent based on the weight of the termite bait can be used.

After mixing, the termite bait can be compacted. This compacted termite bait can take any useful form, such as, tablets, briquettes, pellets, granules, etc. These types of forms can be made by any process known in the art. In another embodiment the compacted termite bait has a density greater than 1 gram per cubic centimeter. Densities less than 1 gram per cubic centimeter can be used but are not preferable in most cases. Once the compacted termite bait has been made, it can be dried. This drying can occur in any manner known in the art that will remove a portion of the water used in making the compacted composition. The dried compacted termite bait should be substantially-free of water so as to inhibit microbial growth when compared to the surrounding environment. In another embodiment of the invention the dried compacted termite bait should have less than about twenty weight percent water based on the total weight of the dried compacted termite bait. In another embodiment of the invention the dried compacted termite bait should have less than about fifteen weight percent water based on the total weight of the dried compacted termite bait. In another embodiment of the invention the dried compacted termite bait should have less than about ten weight percent water based on the total weight of the dried compacted termite bait.

The compacted termite bait can be used to control termites. For example, the compacted termite bait can be placed in the ground, perhaps inside another tube that allows access for termites. The compacted termite bait can also be encased in a durable material, such as disclosed in U.S. Pat. No. 6,857,223 B2 (hereby incorporated by reference). In this patent, a termite bait is hermetically sealed with a non-biodegradable material through which termites can tunnel or chew.

Optional ingredients to include in the termite bait include, but are not limited to, a preservative to retard fungal growth and a protectant such as a bittering agent to provide a safety factor for exposed bait. An attractant is defined as any substance or combination of substances which will lure pests. Examples of attractants are carbon dioxide and terpenes. Feeding stimulants that can be used in the termite baits are, for example, polyhydroxy alcohols such as glycerin, and starch. Examples of preservatives useful in the present invention are 1,2-benzisothiazolin-3-one (PROXEL GXL® Arch Chemicals, Inc. Norwalk, Conn. 06856) methyl paraben (p-hydroxybenzoic acid methyl ester) and propyl paraben (n-propyl p-hydroxybenzoate). Fungistats would also be effective in increasing the longevity of the termite bait and retarding mold growth.

The termite bait can be place in an area where at least one termite would be able to come across the termite bait. For example, the termite bait can be placed into the ground. As another embodiment, the termite bait can be placed in a termite station that is in the ground. Such stations and methods are known in the art, for example, in U.S. Pat. Nos. 6,016,625; 6,370,812 and 6,857,223. In another embodiment, the termite bait can be used above ground. Such methods are known in the art, for example, U.S. Pat. No. 5,406,744. Once a termite comes into contact with the bait, the termite will eat the bait, or destroy the durable material encasing the bait thereby getting at the bait. Once a portion of the bait is eaten, the termite would recruit other termites from the same colony to come and eat the bait, thereby further contaminating the colony with an insecticide, if the termite bait has insecticide in the bait.

### EXAMPLES

These examples are provided to illustrate certain aspects of this invention. These examples are not meant to limit the scope of the invention.

### Example One

### Making an Insecticide Concentrate

Insecticide Concentrate Table

| Ingredient | Weight Percent |
|---|---|
| Noviflumuron | 50.5 |
| Water | 38.1 |
| Pluronic P-104 | 10.4 |
| Proxel GXL | 0.7 |
| Antifoam B | 0.3 |

Noviflumuron is an insecticide available from Dow AgroSciences LLC. Pluronic P-104 is a polyoxylene-polyoxyethylene block copolymer and is available from BASF Corporation. Proxel GXL is an biocidal solution of 1,2-benzisothiazolin-3-one and is available from Arch Chemicals, Inc. Antifoam B is a silicone antifoam emulsion and is available from Dow Corning.

A insect concentrate containing the amounts of ingredients in the Insecticide Concentrate Table was prepared as follows. Pluronic P-104 and water were mixed together to form a solution containing 23.3 weight percent Pluronic P-104 based on the total weight of the mixture (Pluronic P-104 plus water) (“First Mixture”). The Insect Concentrate was made by mixing together and wet milling the First Mixture, the noviflumuron, the Proxel GXL, and the Antifoam B in the amounts required to achieve the indicated weight percents.

### Example Two

### Making a Termite Bait

Termite Bait Table

| Ingredient | Weight Percent |
|---|---|
| Alpha cellulose | 87.7 |
| Glucose | 9.5 |
| Citric Acid | 1.3 |
| Dibasic Sodium Phosphate | 0.5 |
| Insect Concentrate | 1.0 |

Alpha cellulose is available from International Fiber Corporation as AlphaCel* BH100. Glucose is commonly available from multiple suppliers. Citric acid is commonly available from multiple suppliers. Dibasic Sodium Phosphate is commonly available from multiple suppliers.

A termite bait containing the amounts of ingredients in the Termite Bait Table was prepared as follows. Alpha-cellulose, glucose, citric acid, and dibasic sodium phosphate were mixed until substantially uniform in a Forberg mixer (“Alpha Mixture). Prior to the Insecticide Concentrate being added to the Alpha Mixture, the Insecticide Concentrate was diluted in an amount of water equal to approximately 0.2× the weight of alpha-cellulose to be compacted. This water provided moisture to aid the compaction process. The diluted Insecticide Concentrate was sprayed onto the Alpha Mixture to form a Beta Mixture. The Beta Mixture was then transferred from the mixer to a briquetter for compaction. The briquetter used to compact the Beta Mixture was a Komarek B100-A two roll-mill. This was equipped with a pair of rolls that make four rows of “pillows”. The dimensions of the rolls were 5-in O.D.×2-in. wide. The briquettes formed were typically about 0.4-in×0.4-in×0.25-in thick. The processing conditions on the briquetter for the Beta Mixture are: Pre-load pressure of 1450 psig; Roll-speed setting 2.0-4.0; and Feeder speed setting 3.0-7.0. Following collection, briquettes were dried at room temp or in a heated walk-in oven (typically, 65° C.) to remove residual moisture to a measured level below 10 wt. %. The briquettes were then screened to remove fines, thus presenting a final form that was useful as a termite bait.

### Example Three

### Testing a Termite Bait

A standard one-way feeding choice test was used to compare termite feeding on the different bait treatments. The testing set-up consisted of a plastic harborage chamber (5.5 cm round container with ventilated lid) containing medium vermiculite/white river sand/water mixture of ca. 1:1:1. The harborage chamber was connected to the bait foraging chamber (100×25 cm plastic Petri dish) by 1/32″ Tygon tubing that was seven cm in length. For each test, a single briquette of each bait sample was placed approximately 0.5″ apart inside the foraging chamber test unit. Each bait sample was weighed before testing. The bioassays were held in total darkness in a laboratory environment for seven days (10 d for R. virginicus test 3; 4/05) at 28° C. and 80% RH. Termite species tested were Reticulitermes flavipes, Reticulitermes virginicus and Heterotermes aureus. The Reticulitermes spp. were collected in Mississippi and the Heterotermes aureus were collected in Arizona and then shipped overnight to Dow AgroSciences in Indianapolis, Ind. A total of 100 termites were infested in each choice test unit for R. virginicus and R. flavipes while 200 H. aureus termites were infested in each bioassay test unit. Each choice test was replicated six times for R. virginicus and R. flavipes, and H. aureus was replicated seven times. Three controls of each treatment were held under the same laboratory conditions to correct for weight changes. At the termination of each test, bait samples were oven dried (400° F. for 8 hours), allowed to cool overnight in a dessicator, and then weighed to determine consumption. The data were analyzed using the paired T-test (p=0.10) to determine consumption differences between the bait samples.

### Bait Samples (Choices):

1. dry Comparison Bait vs. wet Comparison Bait; and

2. dry Inventive Bait vs. wet Comparison Bait.

The Comparison Bait was made in a similar manner as the Inventive Bait above, except the Comparison Bait had no glucose, citric acid, or dibasic sodium phosphate.

The wet treatments were treated with Ice Mountain de-ionized water; each briquette was treated with 0.86 ml water/g at time of test initiation.

As shown in Table 1, R. virginicus significantly preferred wet Comparison Bait vs. dry Comparison Bait in all three tests with the palatability ratio in favor of the wetted bait 3-11× depending on the test. However, when wet Comparison Bait was given as a choice vs. dry Inventive Bait there were no significant differences noted. Table 2 describes results for R. flavipes and H. aureus. Similar to R. virginicus, R. flavipes significantly preferred the wetted Comparison Bait vs. dry Comparison Bait (borderline significance, p=0.099) with a palatability ratio in favor of the wetted bait at 3.67×. Again however when wet Comparison Bait was compared to dry Inventive Bait there was no significant difference but the palatability ratio favored the dry Inventive Bait 1.37×. Heterotermes aureus also preferred (borderline statistical significance, p=0.102) the wetted Comparison Bait vs. the dry Comparison Bait. Similar to the other species tested, there was no significant difference noted for Comparison Bait vs. Inventive Bait dry for H. aureus although the palatability ratio (dry Inventive Bait vs. wet Comparison Bait) favored Inventive Bait, 2.54×. Overall the data indicate that for all three species of subterranean termites tested (R. virginicus, R. flavipes and H. aureus), wetted Comparison Bait was preferred over dry Comparison Bait, and there were no significant differences for consumption of dry Inventive Bait vs. wetted Comparison Bait. Because there was no difference or greater consumption with Inventive Bait for a given species this means wetting the Inventive Bait will not be necessary thereby saving the user time and materials.

TABLE ONE
One-way paired choice test results of comparative feeding on Dry
Comparison Bait vs. Wet Comparison Bait and Dry Inventive Bait vs.
Wet Comparison Bait for Reticulitermes virginicus.

| | consumption (mg) | |
|---|---|---|
| | for 7-10 days | Palatability Ratio |
| Bait Choice | Mean ± SEM | (Highest/Lowest) |
| Wet Comparison Bait | 7.27 ± 0.902 a | 3.74 |
| vs. | 1.94 ± 0.751 b | |
| Dry Comparison Bait | (p value = 0.018) | |
| R. virginicus Test 1 | | |
| Dry Inventive Bait | 2.86 ± 0.686 a | 1.37 |
| vs. | 2.46 ± 0.807 a | |
| Wet Comparison Bait | (p value = 0.731) | |
| R. virginicus Test 1 | | |
| Wet Comparison Bait | 11.04 ± 3.50 a | 3.42 |
| vs. | 3.23 ± 1.88 b | |
| Dry Comparison Bait | (p value = 0.087) | |
| R. virginicus Test 2 | | |
| Dry Inventive Bait | 8.08 ± 6.26 a | 1.07 |
| vs. | 8.63 ± 3.04 a | |
| Wet Comparison Bait | (p value = 0.946) | |
| R. virginicus Test 2 | | |
| Wet Comparison Bait | 26.65 ± 2.53 a | 11.49 |
| vs. | 2.32 ± 1.17 b | |
| Dry Comparison Bait | (p value = 0.001) | |
| R. virginicus Test 3 | | |
| Dry Inventive Bait | 8.51 ± 3.07 a | 1.83 |
| vs. | 15.63 ± 5.11 a | |
| Wet Comparison Bait | (p value = 0.393) | |
| R. virginicus Test 3 | | |

| | |
|---|---|
| Each choice test replicated | Within each choice test, means |
| 6 times, 100 termites per | followed by same letter are not |
| rep. Test 1 & 2 held for 7 d, | significantly different |
| Test 3 held for 10 d. | (T-Test; p > 0.1) |

TABLE 2
One-way paired choice test results of comparative feeding
on Dry Comparison Bait vs. Wet Comparison Bait and
Dry Inventive Bait vs. Wet Comparison Bait For
Reticulitermes flavipes and Heterotermes aureus.

| | consumption (mg) | |
|---|---|---|
| | for 7 days | Palatability Ratio |
| Bait Choice | Mean ± SEM | (Highest/Lowest) |
| Wet Comparison Bait | 27.58 ± 5.62 a | 3.67 |
| vs. | 7.51 ± 4.44 b | |
| Dry Comparison Bait | (p value = 0.099) | |
| R. flavipes | | |
| Dry Inventive Bait | 18.33 ± 3.99 a | 1.37 |
| vs. | 13.35 ± 3.48 a | |
| Wet Comparison Bait | (p value = 0.533) | |
| R. flavipes | | |
| Wet Comparison Bait | 3.16 ± 1.08 a | 5.88 |
| vs. | 0.54 ± 0.54 a | |
| Dry Comparison Bait | (p value = 0.102) | |
| H. aureus | | |
| Dry Inventive Bait | 5.33 ± 0.86 a | 2.54 |
| vs. | 2.10 ± 1.01 a | |
| Wet Comparison Bait | (p value = 0.115) | |
| H. aureus | | |

| | |
|---|---|
| Reps = 6 for R.f. and 7 for H.a. | Within each choice test, means followed |
| 100 termites per rep for R.f | by same letter are not significantly |
| and 200 termites for H.a. | different (T-Test; p > 0.1) |

What is claimed is:

1. A termite bait comprising:
(a) cellulose;
(b) at least one sugar; and
(c) at least one acid
wherein said termite bait is substantially-free of water.

2. A termite bait according to polyoxyethylene claim 1 further comprising:
(d) at least one insecticide.

3. A termite bait according to claim 2 wherein said termite bait has less than about twenty weight percent water based on the total weight of said termite bait.

4. A termite bait according to claim 3 wherein said termite bait has less than about fifteen weight percent water based on the total weight of said termite bait.

5. A termite bait according to claim 4 wherein said termite bait has less than about ten weight percent water based on the total weight of said termite bait.

6. A termite bait according to claim 5 wherein said termite bait is encased in or contained in a durable material.

7. A process comprising mixing the components of a termite bait according to claims 5 together to make said termite bait.

8. A process comprising placing a termite bait according to claim 5, in an area where at least one termite would be able to come across said termite bait.

9. A termite bait consisting essentially of: cellulose; at least one sugar; at least one acid; and at least one insecticide wherein said termite bait has less than about ten weight percent water based on the total weight of said termite bait.

10. A termite bait consisting of cellulose; at least one sugar; at least one acid; at least one insecticide; water; dibasic sodium phosphate; polyoxylene-polyoxyethylene block copolymer; 1,2-benzisothiazolin-3-one; and a silicone antifoam emulsion wherein said termite bait has less than about ten weight percent water based on the total weight of said termite bait.
